(19) United States
(12) Patent Application Publication
(10) Pub. No.: US 2002/0103554 A1
(43) Pub. Date: Aug. 1, 2002

(54) Interactive audio system

(75) Inventors: Alistair Neil Coles, Bath (GB); Lawrence Wilcock, Wiltshire (GB); Roger Cecil Ferry Tucker, Monmouthsire (GB)

Correspondence Address: HEWLETT-PACKARD COMPANY, Intellectual Property administration, P.O. Box 272400, Fort Collins, CO, 80527-2400, US

(73) Assignee: Hewlett-Packard Company

(21) Appl. No.: 10/058,252

(22) Filed: Jan. 29, 2002

(30) Foreign Application Priority Data
Jan. 29, 2001 (GB) 0102230.0
Nov. 20, 2001 (GB) 0127751.6

(51) Int. Cl. H04B 3/00; G06F 17/00

(52) U.S. Cl. 700/94; 381/77

(57) ABSTRACT

An interactive audio system comprises an audio source terminal 11 and a audio playback terminal 13 connected to each another by a wireless data link 14. The playback terminal 13, in this case, is in the form of a mobile telephone receiver. The source terminal 1 comprises a source computer 5 provided at some fixed network core. Connected to the playback terminal 13 is an audio transducer 15, and a user control device 17. The wireless data link 14 is established over a network connection which is set-up using an existing cellular telecommunications network (as are used in mobile telephony systems). In use, the source terminal 11 acts as a device by which the playback terminal 13 can access particular services. The presentation of available services is not performed using visual data displayed at the remote terminal, but instead, audible sound is used to present services. The services are represented by audio components which are transmitted from the audio source terminal 11 over the data link 14. A user is able to select an audio component as a focus component by using the user control device 17. The focus component is transmitted at a higher bit-rate than the non focus components so as to maintain the required bandwidth of the data link at a suitable level.

This invention relates to an interactive audio system, to a playing terminal for use in an interactive audio system, and to a method of operating an interactive audio system.

The use of sound as a means of presenting computer-based services previously represented in visual form (e.g. on a computer monitor) has been proposed. In particular, it has been proposed that spatialisation processing of different sounds is performed such that the sounds, when played through loudspeakers or some other audio transducer, are presented at particular positions in the three-dimensional audio field. It is envisaged that this will enable Internet-style browsing using only sound-based links to services.

Such a three-dimensional audio interface will use spatialisation processing of sounds to present services in a synthetic, but realistically plotted, three-dimensional audio field. Sounds, representing services and/or information could be placed at different distances to the front, rear, left, right, up and down of the user. An example of a service is a restaurant. A pointer to the restaurant (the equivalent of a hyperlink) can be positioned in the audio field for subsequent selection. There are several ways in which the ‘audio hyperlink’ can be represented, for example by repeating a service name (e.g. the name of the restaurant) perhaps with a short description of the service, by using an earcon for the service (e.g. a memorable jingle or noise), or perhaps by using an audio feed from the service.

Such a system relies upon a high quality audio interface which is capable of rendering a three-dimensional audio field. Given that each sound, representing a service, is likely to be sent to a user's terminal from a remote device (e.g. the service provider's own computer) it follows that a data link is required. Where the data link has limited bandwidth, and is susceptible to interference and noise (for example, if a wireless telephony link is used) or if the channel employs lossy audio codecs (coder-decoders), it is likely that the link will degrade the three-dimensional nature of the audio. This may have the effect of masking any user-perception of three-dimensional positioning of sounds.

This problem can be reduced if each audio component, i.e. each set of data relating to a particular sound, is transmitted independently to the user's terminal where the components are then combined to form the spatialisation processed data. This processed data is not subjected to the lossy transmission link. However, such a system will require larger overall bandwidth in order to carry the multiple audio components. In many network applications, particularly mobile wireless networks, the bandwidth of the access link or channel is a limited and expensive commodity.

According to a first aspect of the present invention, there is provided an interactive audio system comprising: an audio source; a playing terminal connected to the audio source by means of a data link; and an audio transducer and a user control device connected to the playing terminal, wherein the audio source is arranged to transmit a plurality of audio components to the playing terminal by means of the data link, each audio component comprising audio data relating to an audible sound or track, the playing terminal being arranged to output the audible sound or track corresponding to each audio component, by means of the audio transducer, the user control device being arranged to enable user-selection of one of the audio components as a focus component based on the user selecting one of the audible sounds or tracks being emitted from the audio transducer, the playing terminal being further arranged to control the quantity of transmitted data, relating to each audio component, sent from the audio source to the playing terminal, the quantity of transmitted data being dependent on the selected focus sound or track.

The system provides a means whereby a user is able to select a particular sound as a ‘focus’, this selection determining the transmission bit-rate for each audio component. In effect, the system uses adaptive control of the transmission side of the system and thus enables the quantity of data for each component to be controlled such that the overall bandwidth is kept to a suitable level. This enables management of bandwidth whilst preserving the facility of a high quality three-dimensional audio interface. More than one focus sound may be present.

In practice, each different sound may be representative of a different service, and in effect, may be considered equivalent to an Internet-style hyperlink. The sound may comprise, for example, a stream of sound indicative of the service, or perhaps a memorable jingle or noise. A user is then able to select, or focus, on a particular sound in the three-dimensional audio field and perform an initiating operation in order to access the service represented by the sound. Another analogy is that each sound could be equated with a window on a computer desktop screen. Some windows might not be the focus window, but will still be outputting information in the background.

The playing terminal may be further arranged to spatially process the audio components so as to add positional data, indicating a position in space, relative to the audio transducer, at which each audio component is to be perceived. The positional data preferably comprises information relating to the three-dimensional position in space at which the audible sound or track is to be perceived.

The quantity of transmitted data may be defined by the transmission bit-rate, the playing terminal being arranged to set the bit-rate of the audio component, selected as the focus component, to a first predetermined bit-rate, and the bit-rate of the or each other audio component to a second predetermined bit-rate. The first and second predetermined bit-rates are preferably set such as to enable higher quality audio reproduction of the focus component as compared with the audio reproduction of the or each other audio component. This decision is made on the basis that the focus component is the component to which the user has particular interest at that time.

The playing terminal may be arranged to control the quantity of transmitted data sent from the audio source by means of (a) causing the audio source to stream the focus component at a predetermined bit-rate, and (b) causing the audio source to transmit, for each non-focus component, a non-continuous data burst of audio data relating to the sound or track, or a fraction of the sound or track. The playing terminal can be arranged to receive the burst of audio data, relating to each non-focus component, and to store the burst of data for subsequent replaying at the playing terminal. In this way, the audio components which are not currently the primary focus of the user, are sent in the form of a burst of data (which may be a short amount, or even a sample of the audio data) as opposed to a continuous audio stream. At the user terminal, this burst or sample is stored and then repeated in the audio mix at the appropriate three-dimensional position. The bandwidth occupied by these audio components is thereby very small. When a component becomes the primary focus of the user, the audio source is preferably requested to transmit a continuous stream of audio to the user source, this stream replacing the repeating burst or sample in the three-dimensional audio field. Feedback control is of course necessary. The audio samples may be cached on the user device and re-used when a component ceases to be the primary focus. This is analogous to a service being “minimized” as an icon on a visual desktop.

The user control device may comprise a position sensor for mounting on a body part of a user, the position sensor being arranged to cause selection of an audio component as the focus component by means of generating position data indicating the relative position of the user's body part, the playing device thereafter comparing the position data with the positional data for each of the audio components so as to determine the audible sound or track to which the user's body part is directed. The position sensor may be a head-mountable sensor, the playing device being arranged to determine the audible sound or track to which a part of the user's head is directed.

Alternatively, the user control device may comprise a selection switch or button, a trackball, or a voice recognition facility arranged to receive audible commands from a user and to interpret the received commands so as to determine which audio component is selected as the focus component.

The data link may be a wireless data link. The wireless data link may be established over a mobile telephone connection, e.g. using a cellular system. Other wireless data links could be established using IEEE 802.11, wireless LAN, or Bluetooth.

Each audio component may be representative of a link to a further sub-set of audio components stored at the audio source, the playing device being operable to request transmission of the sub-set of audio components in the event that a link represented by an audio component is operated.

According to a second aspect of the invention, there is provided an interactive audio system comprising: a playing terminal connected to one or more audio sources by means of respective data link(s); and an audio transducer and a user control device connected to the playing terminal, wherein the playing terminal is arranged to receive a plurality of audio components from the one or more audio sources by means of the data link(s), each audio component comprising audio data relating to an audible sound or track, the playing terminal being arranged to output the audible sound or track corresponding to each audio component, by means of the audio transducer, the user control device being arranged to enable user-selection of one of the audio components as a focus component based on the user selecting one of the audible sounds or tracks being emitted from the audio transducer, the playing terminal being further arranged to control the quantity of transmitted data, relating to each audio component, sent from the or each audio source to the playing terminal, the quantity of transmitted data being dependent on the selected focus sound or track.

In this respect, it will be appreciated that the audio components may be received from a plurality of different audio sources. For example, two audio sources may each transmit one or more audio components to the playback terminal.

According to a third aspect of the invention, there is provided a playing terminal for use in an interactive audio system, the playing terminal comprising: a first port for receiving a plurality of audio components from a remote audio source, each audio component comprising audio data relating to an audible sound or track which can be played through an audio transducer means connected to the playing terminal; a second port for receiving selection commands from a user control device which is connectable to the playing terminal; and a processing means connected to the first and second ports, wherein the processing means is arranged to (a) receive the audio components from the first port and to play the audible sound or track relating to each audio component by means of the audio transducer, (b) receive a selection command from the second port, the selection command being indicative of one of the audible sounds or tracks currently selected by a user as a focus sound or track, and (c) send a control signal to the audio source by means of the first port, the control signal indicating the quantity of data, relating to each audio component, to be transmitted from the audio source to the playing terminal, the quantity of data being dependent on the audio component selected as the focus component.

According to a fourth aspect of the invention, there is provided a method of operating an interactive audio system, the method comprising: receiving, at a playing terminal, a plurality of audio components transmitted over a data link from a remote audio source, each audio component comprising audio data relating to an audible sound or track; playing each of the audio components so as to output their respective audible sound or track from an audio transducer connected to the playing terminal; selecting one of the audible sounds or tracks as a focus sound or track; and in response to the selection step, transmitting a control signal to the remote audio source so as to control the quantity of transmitted data, relating to each audio component, at which the audio components are transmitted from the audio source, the quantity of transmitted data being dependent on the selected focus sound or track.

Preferred features of the method are detailed in the appended set of claims.

According to a fifth aspect of the invention, there is provided a computer program stored on a computer-usable medium, the computer program comprising computer-readable instructions for causing a processing device to perform the steps of: receiving a plurality of audio components transmitted over a data link from a remote audio source, each audio component comprising audio data relating to an audible sound or track; playing each of the audio components so as to output their respective audible sound or track from the audio transducer connected to the processing device; setting one of the audible sounds or tracks as a focus sound or track; and in response to the setting step, transmitting a control signal to the remote audio source so as to control the quantity of transmitted data, relating to each audio component, at which the audio components are transmitted from the audio source, the quantity of transmitted data being dependent on the focus sound or track.

The invention will now be described, by way of example, with reference to the accompanying drawings, in which:

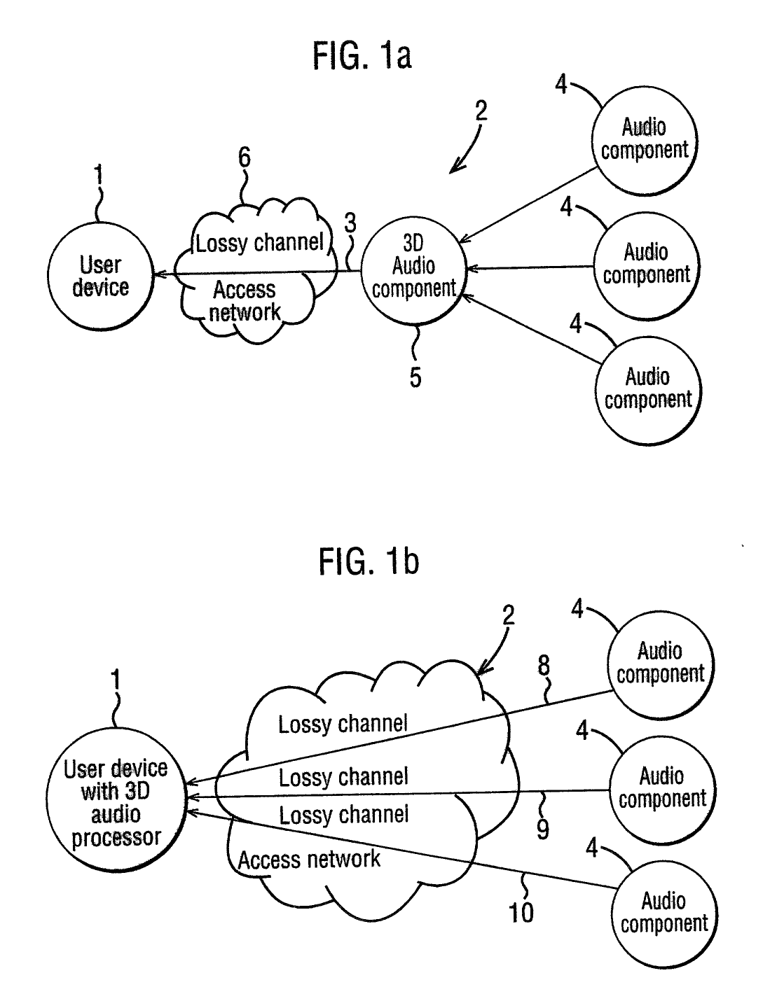

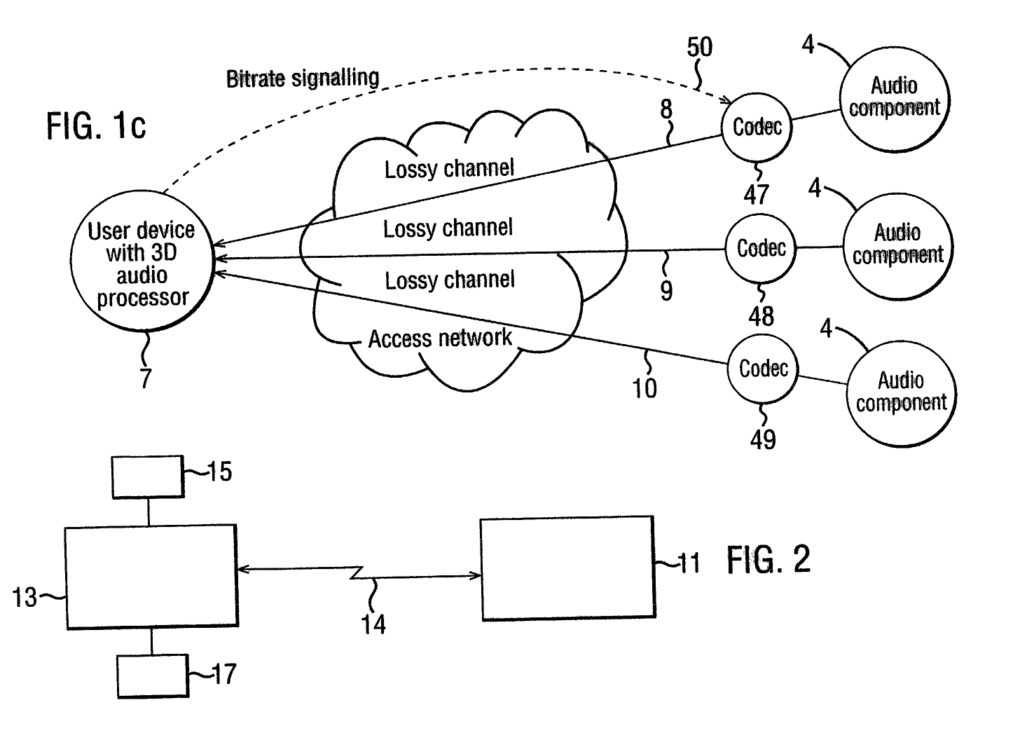

FIGS. 1a, 1b and 1c are diagrams showing different ways in which audio processing can be performed in an audio system;

FIG. 2 is a block diagram showing an overview of the hardware components in an interactive audio system according to a first embodiment of the invention;

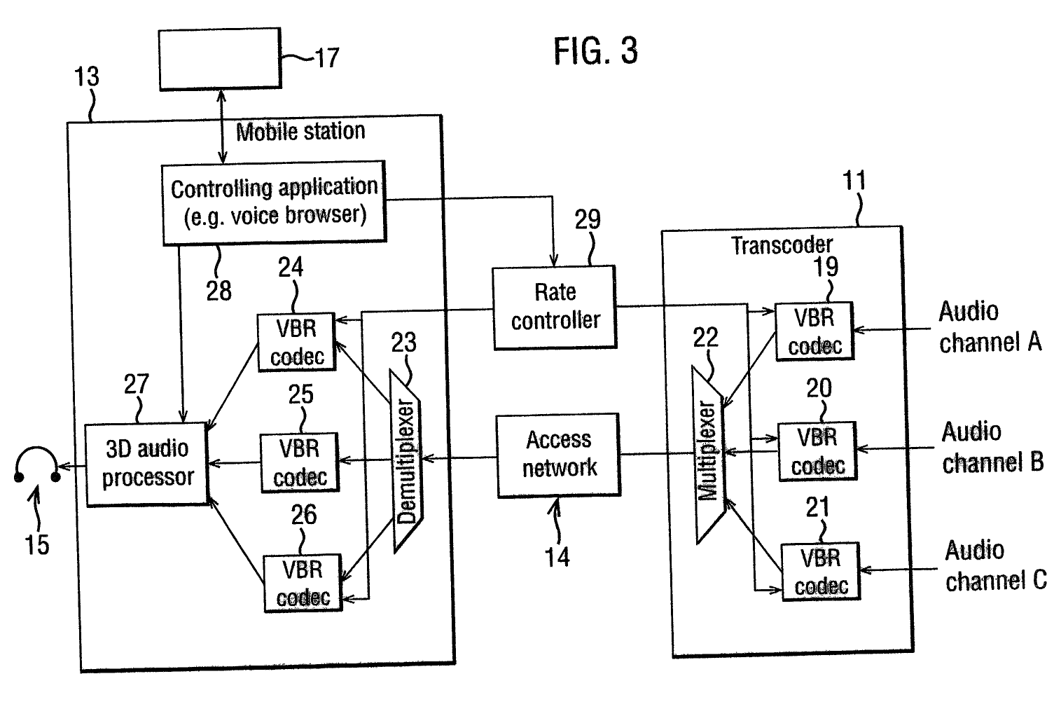

FIG. 3 is a block diagram showing the main functional elements contained within the hardware components of FIG. 1;

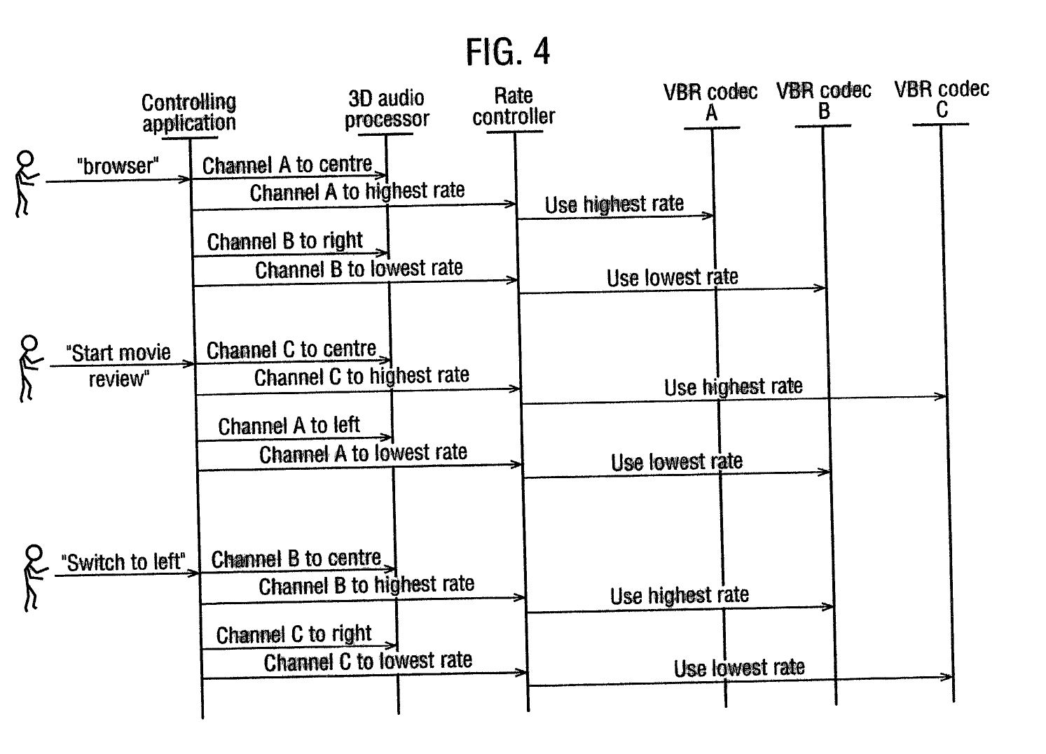

FIG. 4 is a diagram showing a typical sequence of interactions between the functional elements of FIG. 3;

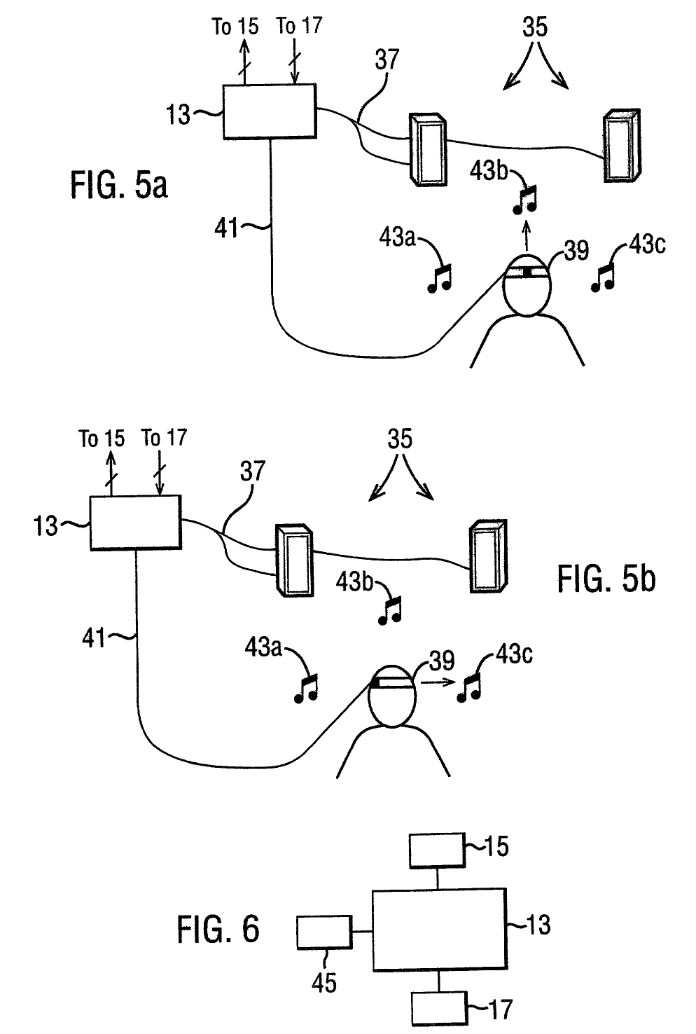

FIGS. 5a and 5b are perspective views of an interactive audio system according to a second embodiment of the invention;

FIG. 6 is a block diagram showing the hardware components in an interactive audio system according to a third embodiment of the invention.

Referring to FIGS. 1a, 1b, and 1c, different methods of generating spatially processed signals are shown. These Figures are intended to provide background information which may be useful for understanding the invention.

In FIG. 1a, a user device 1 is shown connected to an audio source 2 by means of a data link 3. At the audio source 2 are provided a plurality of audio components 4, each comprising audio data relating to a plurality of audible sounds or tracks. The audio components are input to a three-dimensional audio processor 5 for transmission over the data link 3. The audio processor 5 generates spatially processed data representing a composite description of where each set of audio data is to be plotted in three-dimensional space. The data link 3 is established using an access network 6. Due to limited available bandwidth, processed data subsequently transmitted over this lossy channel will result in a degradation of the three-dimensional spatialisation effect.

The degradation of the three-dimensional spatialisation effect can be reduced using the system shown in FIG. 1b. Here, the user device 7 is provided with an audio processor. In this case, each audio component is transmitted separately to the user device 7 (or rather the audio processor of the user device) by means of separate channels 8, 9, and 10 over the access network 6. In this way, the spatialisation processing is performed after the link and so there will be no degradation of the spatialisation effect. However, there is the disadvantage that the link requires a greater total bandwidth to carry all three channels 8, 9 and 10. In many network applications, particularly mobile network applications, the bandwidth of the access network is a limited and expensive commodity.

FIG. 1c shows a modified version of FIG. 1b, and summarises the technique employed in the embodiments which will be described below. Briefly put, each audio component 4 is transmitted using a respective codec 47, 48, 49, the transmission bit-rates of which are controlled by a signal (represented in FIG. 1c by numeral 50) sent back from the user device 7.

Regarding the first method, i.e. that shown in FIG. 1a, this is not used and forms no part of the invention. Its inclusion is merely for illustrative purposes. Indeed, the preferred embodiment of the invention uses the type of system shown in FIGS. 1b and 1c.

Referring to FIG. 2, an interactive audio system according to a first embodiment of the invention comprises an audio source terminal 11 and a audio playback terminal 13 connected to each another by a wireless data link 14. The playback terminal 13, in this case, is in the form of a mobile telephone receiver, but could also be a personal computer (PC), or even a personal digital assistance (PDA) or other portable device. The source terminal 1 comprises a source computer 5 provided at some fixed network core. Connected to the playback terminal 13 is an audio transducer 15, and a user control device 17. The wireless data link 14 is established over a network connection which is set-up using an existing cellular telecommunications network (as are used in mobile telephony systems).

In use, the source terminal 11 acts as a device by which remotely located network devices (such as the playback terminal 13) can access particular services. These services can include, for example, E-mail access, the provision of information, on-line retail services, and so on. The source terminal 11 essentially provides the same utility as a conventional Internet-style server. However, in this case, the presentation of available services is not performed using visual data displayed at the remote terminal, but instead, audible sound is used to present services.

Referring to FIG. 3, which shows the main functional components within the interactive audio system, it is seen that the source terminal 11 comprises first, second and third codecs 19, 20 and 21 for receiving, respectively, first, second and third audio components via audio channels A, B and C. As will become clear below, each audio component corresponds to a particular service which can be accessed either directly from the source terminal 11 (i.e. from an internal memory), or by indirect means (i.e. by a further network connection to a remote device storing the information).

The first to third codecs 19, 20, and 21 are connected at their outputs to a multiplexer 22 which, in turn, is connected to the access network (over the data link 14) when a suitable connection is made with the playback terminal 13. The multiplexer 22 multiplexes the data from the first to third codecs 19, 20 and 21 and feeds, via the access network, the multiplexed signals for input to a demultiplexer 23 at the playback terminal 3. The demultiplexed signals are outputted from the demultiplexer 23 and are input to fourth, fifth and sixth codecs 24, 25, and 26. The nature of the multiplexing/demultiplexing is not too important, and either time or frequency domain multiplexing/demultiplexing can be employed, so long as the three separate audio components are recoverable at the playback terminal 13.

The codecs 19, 20, 21, 24, 25 and 26 are, in this case, variable bit-rate speech codecs. Such codecs are able to encode data at a number of bit-rates and can dynamically and rapidly switch between these different bit-rates when encoding a signal. This allows the encoded bit-rate to be varied during the course of transmission. This can be useful when it becomes necessary to accommodate changes in access network bandwidth availability due to congestion or signal quality. An example variable bit-rate codec is the GSM Adaptive Multi Rate (AMR) codec. The AMR codec provides eight coding modes providing a range of bit-rates for encoding speech: 4.75 kbit/s, 5.15 kbit/s, 5.9 kbit/s, 6.7 kbit/s, 7.4 kbit/s, 7.95 kbit/s, 10.2 kbit/s, and 12.2 kbit/s. When operating in a coding mode, the input signal to such a codec is sampled at a rate of 8 kHz, and 20 ms frames of input samples are encoded into variable length frames according to the coding mode. In a decoding mode, the frames of coded samples are decoded into 20 ms frames of samples. The degradation in quality in the output relative to the input is more severe for the lower bit-rates than for the higher bit-rates.

In the case of the first to sixth codecs 19, 20, 21, 24, 25, and 26, the rate at which each codec endodes or decodes a signal is determined by a rate controller 29, which feeds control signals to each of the codecs. The rate controller 29 is connected to, and is ultimately under the control of, a controlling application 28. In this case, the controlling application 28 is a voice browser, that is, a piece of user-interface software designed to receive commands in the form of audible speech inputted through a microphone, i.e. the user-control device 17. The voice browser 28 also controls the operation of the audio processor 27 so as to create the required user interface effects.

The output from the fourth, fifth and sixth codecs 24, 25 and 26 are fed to the audio processor 27 which spatially processes the received (and decoded) audio components. More specifically, the audio processor 27 adds positional information to each audio component such that a composite set of data, representing the desired audio field to be outputted by the audio transducer means 15, is generated. The positional information assigned to each audio component is the three-dimensional position, in space, at which the audible sound or track represented by the audio component, is intended to be perceived by a user. In this respect, it will be appreciated that three-dimensional processing and presentation of sound is commonly used in many entertainment-based devices, such as in surround-sound television and cinema systems. The operation by which the services, represented by the three components provided at the source terminal 11, are accessed and output by the playback terminal 13, will now be described.

Initially, the data link 14 is established between the source terminal 11 and the playback terminal 13 by means of a user invoking a dial-up connection to the audio source terminal 11. This data link 14 is established over a suitable access network. As will be appreciated by those skilled in the art, the data link will have restricted bandwidth, and be prone to interference and noise.

Once the data link 14 is established over the access network, initially, only first and second audio components are set-up, received via audio channels A and B. Audio channel A conveys a first audio component, which is output from the voice browser 28 itself (the link between the voice browser and channel A not being shown in FIG. 3), whilst audio channel B conveys the second audio component, which is output from a remote traffic alert service. The output from channels A and B is encoded, respectively, by the first and second codecs 19 and 20. After the multiplexing and demultiplexing stages, the first component is decoded by the fourth codec 24, whilst the second audio component is decoded by the fifth codec 25. The decoded signals are then input to the audio processor 27. The voice browser 28 operates to control the audio processor 27 which spatially processes the received first and second audio components by adding positional data. By default, in this initial stage, the second audio component is set-up as a so-called ‘focus’ component. This focus component is assigned positional data such that a user, listening to the audible sounds or tracks generated by the audio processor 27 and outputted to the audio transducer 15, will perceive the focus component at a position to the centre of the audio field (i.e. at a ‘straight-ahead’ position). The other, non-focus component, i.e. the first audio component, is spatially processed such that the audible sound or track is perceived at either the left or right-hand side of the straight ahead position.

The voice browser 28 also acts to control the bit-rate at which the first, second, fourth and fifth codecs 19, 20, 24 and 25 code and decode the audio components. The focus component (the second component) is coded and decoded at the highest bit-rate, whilst the non-focus component (the first component) is coded and decoded and the lowest bit-rate. This is done on the basis that the focus component will be the component which the user is most interested in hearing. Accordingly, in this embodiment at least, the focus component is positioned straight-ahead of the user and is coded and decoded at a high bit-rate so as to preserve audio quality. The non-focus component is coded and decoded at a lower bit-rate so as to maintain the necessary bandwidth of the data link 4 at a reasonable level.

In a next stage, a user directs input to a microphone (i.e. the user-control 17). This input may be inputted by the user speaking a well-known word or phrase (e.g. “browser wake-up”). This is inputted to the voice-browser 28 which runs some form of voice recognition software. As a result of the command, the voice browser 28 directs the audio processor 27 to establish the first audio component (i.e. the voice broswer output) as the focus component. This causes the audio processor to render the decoded first audio component at the straight-ahead position, when heard by a user, and to render the second audio component (the traffic alert service) at a different position in three-dimensional space (e.g. to the right of the user). At the same time, the voice browser 28 directs the rate controller 29 to switch the first and fourth codecs 19, 24 to the higher bit-rate, and to switch the second and fifth codecs 20, 25 to the lower bit-rate.

In a further stage, the user now directs, via the user-control device 17, the voice browser 28 to invoke a movie review service. This causes audio channel C to be opened with a remote connection to a pre-stored address for a movie review service. This results in a third audio component being received at the audio source 11. The voice browser 28 commands the audio processor 27 to render the third component as the focus component and so is spatially processed to locate it at the straight-ahead position. At the same time, the voice browser 28 directs the rate controller 29 to switch the third and sixth codecs 21, 26 to the highest bit-rate, whilst the first, second, fourth and fifth codecs 19, 20, 24, and 25 are set at the lower bit-rate.

The user now has a three-dimensional audio field in which the movie review service is the focus component and is using the highest bit-rate for its coding and decoding function. The voice browser and traffic alert service occupy the left and right positions in the three-dimensional audio field, and are using the lowest codec bit-rate.

If we now assume that the user becomes aware of important traffic news and wishes to change focus from the movie service to the traffic alert service. This may be acieved in a number of ways, for example, by speaking “switch to left” or “go to traffic”. The result is that the browser directs audio processor 27 to render the traffic alert service back as the focus component i.e. in the centre position, and to relegate the movie review service to the right hand position. At the same time, the voice browser 28 directs the rate controller 29 to switch the first, third, fourth and sixth codecs 19, 21, 24 and 26 to the lower bit-rate and the second and fifth codecs 20, 25 to the highest bit-rate.

The sequence of operational interactions between the system components are shown in FIG. 4.

A second embodiment will now be described. In this embodiment, the functional components shown in FIG. 3 are essentially the same, with the exception that the user-control device 17 is a head mountable position sensor rather than a microphone. The method of operation is also slightly different, as will become clear below. The controlling application 28 is no-longer a voice-browser, but includes software to interpret the orientation of the position sensor.

FIG. 5 shows the perspective layout of the playback part of the audio system in this second embodiment. The playback terminal 13 is connected, by a cable 37 to an audio transducer, in this case a set of speakers 35. Also, the playback terminal 13 is connected to a user-control device 15, in this case the head-mountable position sensor 39. This connection is made by means of a cable 41. Of course, cables 37 and 41 could be replaced by wireless data links of the type mentioned previously, e.g. using Bluetooth.

In use, a user is positioned in front of the speakers 35 and wears the head-mountable position sensor 39. The position sensor 39 is arranged to generate direction data which is representative of the direction in which the user is facing (alternatively, it may be chosen to be representative of the gaze direction of the user, i.e. where the user's general direction of sight is directed, though this requires a more sophisticated sensor). Next, the user listens to the sounds being emitted from the speakers 35. As with the first embodiment, first, second, and third audio components are received from the source terminal 11 and combined at the audio processor 27. Accordingly, first, second and third sounds are heard at three different positions in the three-dimensional audio field. The first, second, and third sounds are represented by the symbols 43a, 43b, and 43c. The first sound 43a is heard to the left of the user's head, the second sound 43b in front of the user's head, and the third sound 43c to the right of the user's head. The first, second, and third sounds 43a, 43b, 43c represent different services which may be accessed from the source terminal 11 by means of the data link 14. The sounds are preferably indicative of the actual service they represent. Thus, the first sound 43a may be “E-mail” if it represents an E-mail service, the second sound 43b “restaurant” if it represents a restaurant information service, and the third sound 43c “banking” if it represents an on-line banking service. In use, the user will choose one of the sounds, in three-dimensional space, as a ‘focus’ sound, by means of looking in the general direction of the sound. This focus sound is chosen on the basis that the user will have an interest in this particular sound.

The controlling application 28 in the playback terminal 13 directs the rate controller 29 to send appropriate signals in accordance with the direction data generated by the position sensor 39. By comparing the direction data, and the positional data of each audio component, the controlling application 28 determines the audio component relating to the sound the user has selected as the focus sound. The controlling application 28 then directs the rate controller 29 to adaptively change the bit-rate at which the first to sixth codecs 19, 20, 21, 24, 25 and 26 transmit the audio components, such that the audio component corresponding to the focus sound is sent at the highest bit-rate (as in the first embodiment). The other two audio components (corresponding to the non-focus audio components) are sent at the lowest bit-rate. In this way, the total bandwidth used over the wireless data link 4 can be maintained at a suitable level. Whilst the sound reproduction of the audio data corresponding to the non-focus components will be degraded to some extent, this is acceptable since these components are not of current interest to the user, and in any event, the user will still be able to discern some degree of audible sound at the different positions in space.

Referring to the specific case shown in FIG. 5a, it will be seen that the user's gaze direction is generally in the forwards direction, i.e. towards the second sound 43b. This is the focus sound, and so the audio processor 27 will generate a suitable control signal in order to set the transmission bit-rate at the second and fifth codecs 20, 25 to the high-level, and to set the transmission bit-rate of first, third, fourth and sixth codecs 19, 21, 24 and 26 to the lower-level. Accordingly, the first and second sounds 43a and 43c, are heard by the user with degraded sound quality, and the second, focus sound 43b, is heard with high quality. In FIG. 5b, the user's gaze is in the rightwards direction, i.e. towards the third sound 43c. This then becomes the focus sound and so the audio processor 27 generates a suitable control signal to set the third and sixth codecs 21, 26 to the high-level and the other codecs 19, 20, 24, and 25 to the lower level.

The above-described method, whereby the bit-rate at which the codecs transmit data is adaptively controlled according to the selection of the focus component of the user, is provided by software in the playback terminal 13. This software can be installed on the playback terminal 13 (which can be a conventional PC, as mentioned earlier) which configures the necessary ports to receive the audio components.

Whilst the above-described embodiment utilises a head-mountable position sensor 39, many different user-control devices 17 can be used. For example, the user might indicate the focus component by means of a control switch or button on a keyboard. Alternatively, as in the first embodiment, a voice recognition facility may be provided, whereby the user states directional commands such as “left”, “right”, “up” or “down” in order to rotate the audio field and so bring the desired sound to a focus position. The command may even comprise the sound or jingle itself.

Once the user has decided that a particular sound should be operated (bearing in mind that each sound in the audio field represents a service which can be accessed from the source terminal 11) then, in a further stage, the user can operate the service. This can be performed by the user pressing a particular button on a keyboard, or by saying a keyword, if a voice recognition facility is provided, when the desired service is selected as the focus sound. The effect of operating the service is analogous to a user clicking on an Internet-style hyperlink. By operating the service represented by sound, a further set of sound-based services can be presented as sub-links within the original sound based service. Thus, if the user operates the “E-mail” sound based service, then a further set of sounds may be presented, e.g. “inbox”, “outbox”, “sent E-mails” and so on.

Referring now to FIG. 6, which shows the hardware components in a playback terminal according to a third embodiment of the invention, it will be seen that the playback terminal 13 is similar to that which is shown in FIG. 2, with the exception that a memory 45 is provided. The memory 45 is shown externally to the playback terminal, but can be internal.

In this embodiment, the playback terminal 13 is arranged to control the quantity of data transmitted from the source terminal 11 by means of (a) causing the source terminal to stream the focus component at a predetermined bit-rate, and (b) causing the source terminal to transmit, for each non-focus component, a sample of data relating to a fraction of the sound or track. When the sample of data is received, it is stored in the memory 45, which acts as a cache.

In this way, the audio components which are not currently the primary focus of the user, are sent in the form of a sample, as opposed to a continuous audio stream. At the playback terminal 13, this sample is stored in the memory 45 and then repeated in the audio mix at the appropriate three-dimensional position. The bandwidth occupied by these audio components is thereby very small. When a non-focus component becomes the primary focus of the user, the source terminal 15 is then requested, by means of the controlling application 28, to transmit a continuous stream of audio to the playback terminal 13, this stream replacing the repeating burst or sample in the three-dimensional audio field. This can all be accomplished using essentially the same components and method and software as provided for in either of the first or second embodiments. The audio samples are cached in the memory 45 and are re-used when a component ceases to be the focus.

In the above embodiments, although the interactive audio system has been described with one audio source, it will be appreciated that the audio components might originate from a number of audio sources. Each component might be either multiplexed onto a single transmission channel prior to being sent to the playback terminal 13, in which case the multiplexing device concerned could be considered as a single audio source, or each component could be transmitted independently to the playback terminal, i.e. each being sent on a separate transmission channel, analogous to having several telephone calls being directed to a single handset, in which case there is no single audio source for all of the components.

Further, in the above embodiments, the positional information for each audio component is provided at the audio processor 27 in the playback terminal. This is by no means the only method. A first method, relevant to what has been described above, is where the positional data is determined at the plackback terminal 13, e.g. the playback terminal maintains some history of user interaction with services and moves less recently accessed services further away from the straight-ahead position. In this case, the playback terminal 13 receives a number of audio components which are input to the audio processor 27 and the position for each component is supplied locally. In a second method, the audio source provides a relative mapping of audio components according to their perceived proximity to the centre or focus position. The playing terminal then transforms this map to an absolute three-dimensional positioning. This allows for flexibility in the playback terminal 13 for rendering the audio components in different ways according to implementation choice or user preference, e.g. across a subset of complete three-dimensional space (defined by an arc in the horizontal and vertical planes) or simply across an arc in just the horizontal plane (as suggested by the left, centre, right example). In a third method, the positional data is procided by some other functional element, i.e. other than the audio source or the playback terminal 13. This might be particularly applicable if there are a number of distributed audio sources and a single ‘controller’ that is providing the positioning data for all audio components to the playing terminal.

Whilst the concept of a ‘focus’ sound or track has been described above in relation to a single sound, it is possible for more than one sound or track to be a focus at a particular point in time. More than one audio component could be transmitted at a higher bit-rate than other audio components, so long as the overall bandwidth used in controlled to a suitable level.

As has been described above, a technique is provided in order to minimize, or at least reduce, the bandwidth required to transmit the audio components to the user device (i.e. the playback terminal 13), whilst preserving a high quality three-dimensional audio interface. In this technique, the three-dimensional audio processing is performed at the user device. It is observed that at any point in time, a user will have a primary focus within the audio interface. For example, the user may have selected a restaurant service and be interacting with it. The primary focus may be rendered at the position “straight ahead” in the audio field. It is desirable that the primary focus be rendered as a relatively high quality audio signal. However, other services that are not currently a primary focus can be adequately presented in the audio field by a lower quality signal. It is therefore possible to reduce the bandwidth required for a component in the transmission channel by sending a lower bit-rate (generally meaning lower quality) codec for that component while it is not the primary focus of the user. It is noted that, as the quality of an audio signal is degraded, it is still possible for that audio signal to be placed accurately in the audio field. When a user (or some programmatic operation) selects a service as a primary focus, the corresponding audio signal is switched to use a higher bit-rate codec. At the same time, services ceasing to be a primary focus are switched to a lower bit-rate codec. In this was the total bit rate required to transmit all components is reduced.

The above techniques are implemented using variable bitrate codecs and a control channel for signalling the required bit-rate/quantity from the user device to the source of each component. Such signalling might also be present in order to control codec bitrate for the purposes of network congestion control or adaptation to channel conditions.

1. An interactive audio system comprising:
an audio source;
a playing terminal connected to the audio source by means of a data link; and
an audio transducer and a user control device connected to the playing terminal,
wherein the audio source is arranged to transmit a plurality of audio components to the playing terminal by means of the data link, each audio component comprising audio data relating to an audible sound or track, the playing terminal being arranged to output the audible sound or track corresponding to each audio component, by means of the audio transducer, the user control device being arranged to enable user-selection of one of the audio components as a focus component based on the user selecting one of the audible sounds or tracks being emitted from the audio transducer, the playing terminal being further arranged to control the quantity of transmitted data, relating to each audio component, sent from the audio source to the playing terminal, the quantity of transmitted data being dependant on the selected focus sound or track.

2. A system according to claim 1, wherein the playing terminal is further arranged for spatially processing the audio components so as to add positional data, indicating a position in space, relative to the audio transducer, at which each audio component is to be perceived.

3. A system according to claim 2, wherein the positional data comprises information relating to the three-dimensional position in space at which the audible sound or track is to be perceived.

4. A system according to claim 1, wherein the quantity of transmitted data is defined by the transmission bit-rate, the playing terminal being arranged to set the bit-rate of the audio component, selected as the focus component, to a first predetermined bit-rate, and the bit-rate of the or each other audio component to a second predetermined bit-rate.

5. A system according to claim 4, wherein the first and second predetermined bit-rates are set such as to enable higher quality audio reproduction of the focus component as compared with the audio reproduction of the or each other audio component.

6. A system according to claim 1, wherein the playing terminal is arranged to control the quantity of transmitted data sent from the audio source by means of (a) causing the audio source to stream the focus component at a predetermined bit-rate, and (b) causing the audio source to transmit, for each non-focus component, a non-continuous data burst of audio data relating to the sound or track, or a fraction of the sound or track.

7. A system according to claim 6, wherein the playing terminal is arranged to receive the burst of audio data, relating to each non-focus component, and to store the burst of data for subsequent replaying at the playing terminal.

8. A system according to claim 3, wherein the user control device comprises a position sensor for being mounted on a body part of a user, the position sensor being arranged to cause selection of an audio component as the focus component by means of generating position data indicating the relative position of the user's body part, the playing device thereafter comparing the position data with the positional data added to each of the audio components so as to determine the audible sound or track to which the user's body part is directed.

9. A system according to claim 8, wherein the position sensor is a head-mountable sensor, the playing device being arranged to determine the audible sound or track to which a part of the user's head is directed.

10. A system according to claim 1, wherein the user control device comprises a selection switch or button.

11. A system according to claim 1, wherein the user control device comprises a voice recognition facility arranged to receive audible commands from a user and to interpret the received commands so as to determine which audio component is selected as the focus component.

12. A system according to claim 1, wherein the data link is a wireless data link.

13. A system according to claim 12, wherein the wireless data link is established over a mobile telephone connection.

14. A system according to claim 1, wherein each audio component is representative of a link to a further sub-set of audio components stored at the audio source, the playing device being operable to request transmission of the sub-set of audio components in the event that a link represented by an audio component is operated.

15. An interactive audio system comprising:
a playing terminal connected to one or more audio sources by means of a respective data link or respective data links; and
an audio transducer and a user control device connected to the playing terminal,
wherein the playing terminal is arranged to receive a plurality of audio components from the one or more audio sources by means of the data link or data links, each audio component comprising audio data relating to an audible sound or track, the playing terminal being arranged to output the audible sound or track corresponding to each audio component, by means of the audio transducer, the user control device being arranged to enable user-selection of one of the audio components as a focus component based on the user selecting one of the audible sounds or tracks being emitted from the audio transducer, the playing terminal being further arranged to control the quantity of transmitted data, relating to each audio component, sent from the or each audio source to the playing terminal, the quantity of transmitted data being dependant on the selected focus sound or track.

16. A playing terminal for use in an interactive audio system, the playing terminal comprising:
a first port for receiving a plurality of audio components from a remote audio source, each audio component comprising audio data relating to an audible sound or track which can be played through an audio transducer means connected to the playing terminal;
a second port for receiving selection commands from a user control device which is connectable to the playing terminal; and
a processing means connected to the first and second ports,
wherein the processing means is arranged to (a) receive the audio components from the first port and to play the audible sound or track relating to each audio component by means of the audio transducer, (b) receive a selection command from the second port, the selection command being indicative of one of the audible sounds or tracks currently selected by a user as a focus sound or track, and (c) send a control signal to the audio source by means of the first port, the control signal indicating the quantity of data, relating to each audio component, to be transmitted from the audio source to the playing terminal, the quantity of data being dependant on the audio component selected as the focus component.

17. A playing terminal according to claim 16, further comprising means arranged to spatially process the audio components so as to add positional data, indicating a position in space, relative to the audio transducer, at which each audio component is to be perceived.

18. A method of operating an interactive audio system, the method comprising:
receiving, at a playing terminal, a plurality of audio components transmitted over a data link from a remote audio source, each audio component comprising audio data relating to an audible sound or track;
playing each of the audio components so as to output their respective audible sound or track from an audio transducer connected to the playing terminal;
selecting one of the audible sounds or tracks as a focus sound or track; and
in response to the selection step, transmitting a control signal to the remote audio source so as to control the quantity of transmitted data, relating to each audio component, at which the audio components are transmitted from the audio source, the quantity of transmitted data being dependant on the selected focus sound or track.

19. A method according to claim 18, further comprising the step of spatially processing the received audio components so as to add positional data, indicating a position in space, relative to the audio transducer, at which each audio component is to be perceived.

20. A method according to claim 19, wherein the positional data comprises information relating to the three-dimensional position in space, relative to the audio transducer, at which the audible sound or track is to be perceived.

21. A method according to claim 18, wherein the quantity of transmitted data is defined by the transmission bit-rate, the playing terminal setting the bit-rate of the audio component, selected as the focus component, to a higher bit-rate than that of each of the other audio components.

22. A method according to claim 18, wherein the playing terminal controls the quantity of transmitted data sent from the audio source by means of (a) causing the audio source to stream the focus component at a predetermined bit-rate, and (b) causing the audio source to transmit, for each non-focus component, a non-continuous burst of audio data relating to the sound or track, or a fraction of the sound or track.

23. A method according to claim 22, wherein the playing terminal receives the burst of audio data, relating to each non-focus component, and stores the burst of data for subsequent replaying at the playing terminal.

24. A method according to claim 18, wherein the step of selecting one of the audible sounds or tracks as a focus sound or track comprises operating a control device in the form of a position sensor mounted on a body part of a user, the position sensor causing selection of an audio sound or track as the focus sound or track by means of generating position data indicating the relative position of the user's body part, the playing device thereafter comparing the position data with the positional data for each of the audio components so as to determine the audible sound or track to which the user's body part is directed.

25 A method according to claim 24, wherein the position sensor is a head-mountable sensor, the playing device determining the audible sound or track to which a part of the user's head is directed.

26. A method according to claim 18, wherein the step of selecting one of the audible sounds or tracks as a focus sound or track comprises operating a control device in the form of a selection switch or button.

27. A method according to claim 18, wherein the step of selecting one of the audible sounds or tracks as a focus sound or track comprises operating a control device in the form of a voice recognition facility which receives audible commands from a user and interprets the received commands so as to determine which audible sound or track is selected as the focus sound or track.

28. A method according to claim 18, wherein the data link is a wireless data link.

29. A method according to claim 28, wherein the wireless data link is established over a mobile telephone connection.

30. A method according to claim 18, wherein each of the audible sounds or tracks represents a link to a further sub-set of sounds or tracks, the method further comprising the step of operating one of the links so that audio components relating to the further sub-set of sounds or tracks are transmitted from the audio source to the playing terminal over the data link.

31. A method according to claim 18, wherein each of the audible sounds or tracks represents a link to a web-site of a service provider.

32. A computer program stored on a computer-usable medium, the computer program comprising computer-readable instructions for causing a processing device to perform the steps of:
receiving a plurality of audio components transmitted over a data link from a remote audio source, each audio component comprising audio data relating to an audible sound or track;
playing each of the audio components so as to output their respective audible sound or track from the audio transducer connected to the processing device;
setting one of the audible sounds or tracks as a focus sound or track; and
in response to the setting step, transmitting a control signal to the remote audio source so as to control the quantity of transmitted data, relating to each audio component, at which the audio components are transmitted from the audio source, the quantity of transmitted data being dependant on the focus sound or track.

33. An interactive audio system comprising:
an audio source means;
audio playing means connected to the audio source means by a communication means; and
an audio production means and a user control means connected to the audio playing means,
wherein the audio source means is arranged to transmit a plurality of audio components to the audio playing means by means of the communication means, each audio component comprising audio data relating to an audible sound or track, the audio playing means being arranged to output the audible sound or track corresponding to each audio component, by means of the audio production means, the user control means being arranged to enable user-selection of one of the audio components as a focus component based on the user selecting one of the audible sounds or tracks being emitted from the audio production means, the audio playing means being further arranged to control the quantity of transmitted data, relating to each audio component, sent from the audio source means to the audio playing means, the quantity of transmitted data being dependent on the selected focus sound or track.
